(19) United States
(12) Patent Application Publication
(10) Pub. No.: US 2005/0262697 A1
(43) Pub. Date: Dec. 1, 2005

(54) Cutting device for tubular objects

(76) Inventor: Michael A. Stein, Eden Prairie, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/853,742

(22) Filed: May 25, 2004

(51) Int. Cl. B26D 1/00; B26D 3/00

(52) U.S. Cl. 30/92

(57) ABSTRACT

A cutting device for cutting an object (i.e., pipes or tubing), the device comprising a first cutting member and a second securing member pivotally coupled together. The first cutting member generally includes a handle portion and a blade portion extending away from the handle portion, the blade portion having at least one blade edge for cutting a portion of the object, and being moveable along a cutting path. The second securing member can include a handle portion and a cradle portion. Additionally, the device can comprise a positioning or nesting element connected to the second securing member proximate the cradle portion, the positioning or nesting element being adapted to hold and securely position a tube or pipe object such that the longitudinal axis of the target object is aligned and secured generally transverse to the longitudinal axis of the securing member and the cutting path of the blade portion.

### FIELD OF THE INVENTION

The invention relates to devices for cutting. In particular, the invention pertains to cutting tools comprising a blade and a positioning element that can hold tubing or pipes in a desired generally transverse position with respect to the cutting path of the device.

### BACKGROUND OF THE INVENTION

In general, devices for cutting pipes and/or tubes can be categorized into two basic designs. The first category of designs comprise rotating cutters that typically have a wrench-like or pliers-like shape, with a rotating blade that can cut a tube or pipe by rotating the cutting blade around the tube or pipe. Additionally, the rotating cutters can have structure for increasing the pressure on the rotating blade, which allows the blade to cut deeper into the surface of the tube until the tube is cut. These types of cutting devices are generally described in, for example, U.S. Pat. No. 2,970,377 to Olsen, entitled “Pre-Splicing Tool For Removing Covering From Cable,” and U.S. Pat. No. 6,134,997 to Rosanova, entitled “Tube Cutter And Method,” both of which are hereby incorporated by reference herein.

The second category of designs comprise pivotable blade cutters that employ a non-rotatable or fixed blade and a jaw member pivotally disposed together. The pivotal blade cutters can cut a tube or pipe by positioning a tube in the jaw member, and pivoting the non-rotatable blade, generally in a scissor-like manner, to engage and cut a surface of the tube. Examples of such devices are described in, for example, U.S. Pat. No. 6,370,780 to Robertson et al., entitled “Spring-Biased Cutting Tool For Plastic Pipes,” and U.S. Pat. No. 6,658,738 to King, entitled “Pipe And Tubing Cutter,” both of which are hereby incorporated by reference herein.

However, these conventional cutting devices do not comprise sufficient structure for securing tubing or piping objects to the cutting device, which can make it difficult to precisely cut the respective object. Additionally, previous cutting devices lack the structure needed to accurately facilitate a generally 90 degree cut through the surface of the target object. For example, during use of conventional cutting devices, tubing can move relative to the cutting blade, which can lead to tubing sections having undesirable lengths and/or end portions having undesirable cut angles. Due to the number of pipes and tubes that are employed in various applications, and the accuracy often needed in making appropriate cuts, it would be desirable to provide a cutting device which has structure to facilitate precise cutting.

### SUMMARY OF THE INVENTION

In one aspect, the invention relates to a device for cutting an object (i.e., pipes or tubing), the device comprising a first cutting member and a second positioning or securing member pivotally coupled together. The first cutting member generally includes a handle portion and a blade portion extending away from the handle portion, the blade portion having at least one blade edge for cutting a portion of the tube, and being moveable along a cutting path. The second positioning or securing member can include a handle portion and a cradle portion. Additionally, the device can comprise a positioning or nesting element connected to the second member proximate the cradle portion, the positioning element being adapted to hold and securely position a tube or pipe object such that the longitudinal axis of the target object is aligned and secured generally transverse to the longitudinal axis of the securing member and the cutting path of the blade portion. As described above, conventional cutting devices do not provide sufficient support structures for positioning and holding the tubing during cutting of the tube. As a result, the tube can move before or during the cutting process, which can lead to cuts that have undesirable lengths and cutting angles. Furthermore, since some applications require the pipes and/or tubes to be precisely cut, imprecise cuts can increase the costs and/or time associated with a particular application. Thus, it is desirable to immobilize the tubing or pipes during the cutting process in order to facilitate precise cutting. As described herein, the cutting device of the present invention promotes such precision cutting by providing a positioning element proximate the holding cradle of the device such that the tube and piping is secured for a desired orientation relative to the cutting blade.

An object and feature of an embodiment of the cutting device is a positioning element defining at least one generally C-shaped holding/grasping bracket or portion connected to the second securing member, wherein the at least one C-shaped holding portion is adapted to hold and position a tube or pipe object in alignment such that the longitudinal axis of the tube is generally transverse to the axis of the second securing member and the cutting path of the cutting blade.

A further object and feature of an embodiment of the cutting device is a positioning element constructed of a flexible but resilient material, such as known thermopolymers, such that tubing of varying sizes and shapes can be secured therein to provide precision cutting.

Yet another object and feature of an embodiment of the cutting device is a positioning element constructed of two spaced apart and generally C-shaped holding/nesting portions having interior proximate angled edges. As such, the tubular object can be initially inserted or positioned between these spaced apart nesting portions at a generally oblique angle such that the target tubular object can be pivoted or twisted into alignable engagement with the holding portions and their axes, in a generally transverse relationship to the longitudinal axis of the second securing member of the cutting device. This structure further provides ease-of-use, and handleability and engagement benefits during use.

Still another object and feature of an embodiment of the cutting device is a positioning or nesting element selectively connectable along the second member proximate the cradle portion to provide adjustable alignment and securement in receiving and positioning the target tubular object for cutting.

Yet another object and feature of an embodiment of the cutting device is a positioning or nesting element constructed of two or more distinct grasping portions to selectively shroudably engage an outer circumference or surface of the target tubular object.

Another object and feature of an embodiment of the cutting device is a positioning or nesting element constructed of two or more spaced apart and aligned grasping portions generally transverse to the second member, and having angled end edge portions to enable movement of the cutting blade along the cutting path between said spaced apart grasping portions.

Still another object and feature of an embodiment of the cutting device is a positioning element constructed of two or more spaced apart and aligned grasping portions generally transverse to the second member, wherein the grasping portions are generally C-shaped with openings adjacently facing each other to form a tubular object receipt path.

### BRIEF DESCRIPTION OF THE FIGURES

FIG. 1 is a perspective view of a cutting device in accordance with an embodiment of the present invention.

FIG. 2 is a side view of a cutting device in accordance with an embodiment of the present invention.

FIG. 3 is a top view of a cutting device in accordance with an embodiment of the present invention.

FIG. 4 is a perspective view of a cutting device having a positioning element with a tubular object obliquely engaged therein in accordance with an embodiment of the present invention.

FIG. 5 is a perspective view of a cutting device having a positioning element with a tubular object engaged therein in accordance with an embodiment of the present invention.

### DETAILED DESCRIPTION OF THE INVENTION

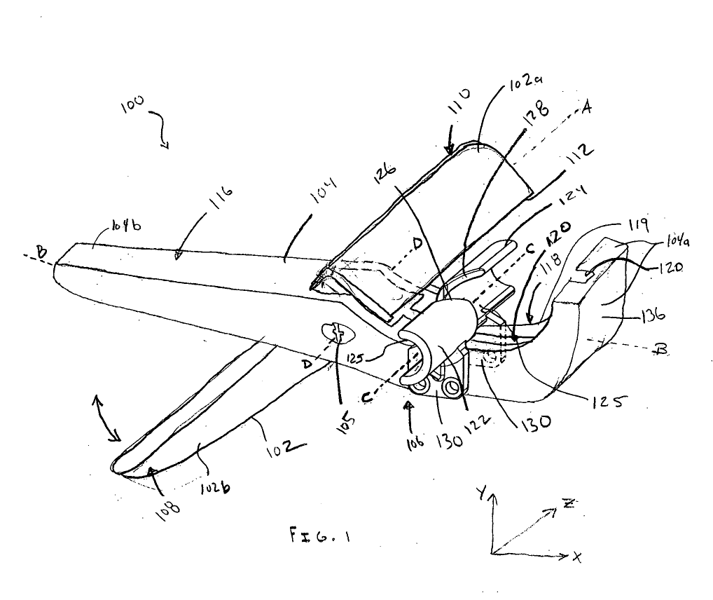

Referring to FIGS. 1-5, the cutting device 100 of the present invention generally comprises a first cutting member 102 and a second positioning or securing member 104, wherein the first member 102 is pivotally connected to the second member 104, and wherein the first member 102 further comprises a front end portion 102a, a back end portion 102b, and a blade portion 110. Generally, the blade portion 110 has at least one blade edge 112 for cutting the tubular object (i.e., tube or pipe) 140. Additionally, the cutting device 100 generally comprises a positioning or nesting element 106 adapted to position and secure the tubular object 140 in a generally transverse and stable orientation relative to the blade portion 110 and the longitudinal axis A of the first cutting member 102. Due to the presence of the positioning element, pipes or tubes 140 can be held securely to facilitate precision cutting as slippage and undesirable pressure wiggle is substantially reduced. Additionally, the positioning element 106 can position a tube or pipe 140 within the cutting device 100 to facilitate a generally 90 degree cut of the tubular object 140. In some embodiments, the positioning element 106 can comprise one or more generally C-shaped nesting/bracket portions 122, 124 coupled or otherwise attached/integrated to the second member 104, which can allow the tube or pipe 140 to be pivotably snapped or otherwise engaged into the bracket(s) 122, 124, positioned, and secured in a desired orientation relative to the cutting blade (i.e., generally transverse). The initial positioning or engagement process is described in more detail herein.

Again referring to FIGS. 1-5, the first cutting member 102 can comprise a handle portion 108 and the blade portion 110 extending away from handle portion 108 along its longitudinal axis A. The handle portions 108 is generally located proximate the back end portion 102b and the blade portion 110 is generally located proximate the front end portion 102a. The blade portion 110 can comprise at least the one blade edge 112 for cutting a tube or a pipe 140. In some embodiments, the blade portion 110 can be coupled to the handle portion 108 by a pin or like fastening devices (not shown), which allows the blade portion 110 and/or blade edge 112 to be changed or adjusted in order to replace a dull blade and/or to cut a tube 140 of differing size, shape, hardness, and the like. As described below, pivotable actuation of the first cutting member 102 relative to the second securing member 104 about axis D can actuate blade portion 110, and blade edge 112 specifically, along the target cutting path. Other known fixed and rotatable blades can be employed as well without deviating from the spirit and scope of the present invention.

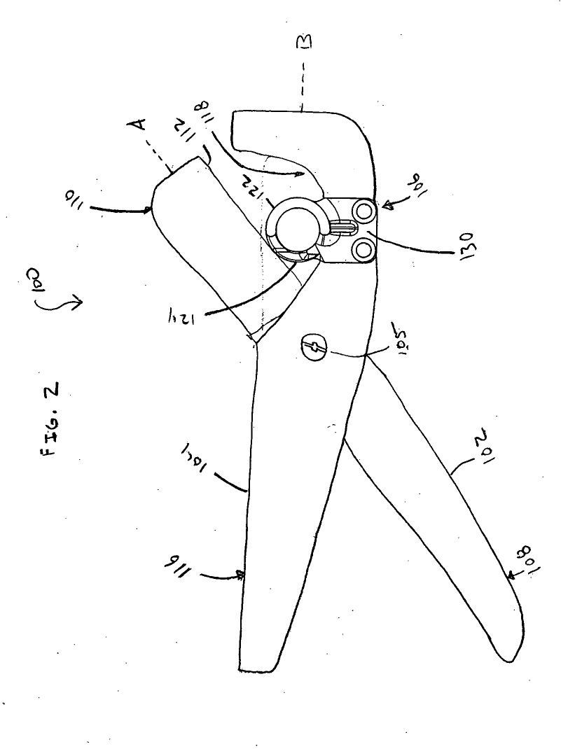

As described above, the cutting device 100 can comprise the first member 102 pivotally coupled to the second member 104, which allows the blade portion 110 and edge 112 to move relative to the second member 104 in a pivotable lever-like action. In some embodiments, the first member 102 and the second member 104 can be pivotally coupled by pivot pin 105 about axis D. Other embodiments may utilize known assemblies, fasteners, and like techniques to facilitate this pivoting lever action. As such, the first and second members 102, 104 engage and disengage in a plier or scissor-like motion. As shown in FIGS. 1 and 2, the second securing member 104 has a longitudinal axis B, and can comprise a handle portion 116, and a cradle portion 118 provided distal the handle portion 116 along said axis B. Generally, the cradle portion 118 can define a recess 119 in the second securing member 104. The recess 119 can have a semi-circular shape or partial concave construction. Other securing or holding structures and forms known to those skilled in the art can be employed as well. One of ordinary skill in the art will recognize that the size and shape of the cradle portion 118 can be guided by the intended application and the shapes and configurations for the particular cutting device 100, tubing, and positioning elements 106. As described below, the blade portion 110 of the first cutting member 102 can be actuated down through the cradle portion 118 of the second securing member 104 by squeezing or levering first member 102 and second member 104 together, bringing axes A, B proximate one another. This levering action ultimately engages the blade edge 112 down into contact with a desired target surface portion of the tubing located within the cradle portion 118 of the positioning element 106 for cutting.

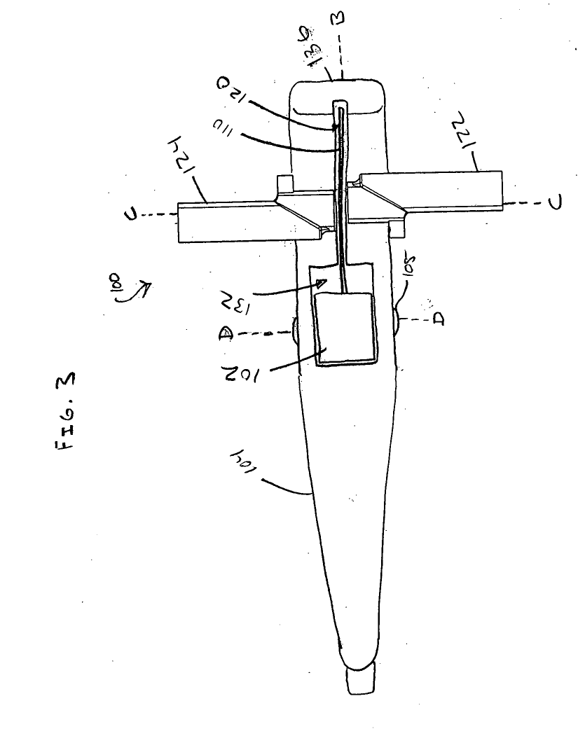

The second securing member 104 can comprise a front end portion 104a, a back end portion 104b, longitudinal axis B, and an opening or channel 132 therethrough for receiving at least the blade portion 110 of the first member 102 to facilitate the above-described pivoting and coupling between the two members 102, 104. Additionally, the cradle portion 118 of the second securing member 104 can include a blade channel 120 proximate the front end portion 104a, which alignably receives at least a portion of the blade 110 and the blade edge 112. As shown in FIG. 3, in some embodiments the blade channel 120 can extend from the front portion 136 of the second securing member 104 to the opening 132. One of ordinary skill in the art will recognize that the size and shape of the opening 132 and the blade channel 120 can be guided by the size of the blade portion 110 employed in a particular embodiment of the cutting device 100. Other configurations known to those skilled in the art for receiving and aligning such blade members can be employed without deviating from the spirit and scope of the present invention.

As described herein, the cutting devices 100 of the present disclosure generally comprise the positioning element 106 to hold and position the tube or pipe 140 during cutting. In various embodiments, the positioning element 106 extends along axis C, and can hold the tubing 140 such that a 90 degree cut is facilitated. Generally, the positioning element 106 can be any mechanical structure which can support and hold a generally elongate tube or pipe 140 along axis C in a generally transverse orientation relative to axis B and the cutting blade 110 of the device. The tubing 140 can be those known to one skilled in the art, including square, rectangular, cylindrical, and like shapes, as well as those constructed of various cuttable materials such as thermopolymers. The tubing 140 extends along an axis E. In one embodiment, the positioning element 106 can comprise holding/nesting portions or brackets 122, 124, which can be connected or integrated to the second securing member 104 proximate the cradle portion 118. In other embodiments, the positioning element 106 can be a single bracket or device 122 for securing the tubing 140 relative to the second securing member 104 and the blade portion 110.

The holding or nesting portions 122, 124 can be attached to the second securing member 104 by fasteners such as, for example, screws, bolts, clips, pins or any myriad of other structures and techniques known to those of ordinary skill in the art. In addition, various assemblies and adjustable mechanisms and devices can be employed to provide selective adjustment and alignment capabilities for the positioning element 106 relative to the second securing member 104 and the cutting path of the blade portion 110. In other embodiments the grasping or nesting portions 122, 124 can be integrally formed or molded as part of the second securing member 104. In alternative embodiments, the positioning element 106 and axis C can be selectively aligned at an angle deviating from generally transverse (with respect to axis B and the second member) to facilitate a cut less than or greater than 90 degrees.

The grasping portions 122, 124 can extend out from the cutting device 100 generally transverse to axis B of the second member 104 and the cutting path/plane of the blade edge 112. In various embodiments, the grasping portions 122, 124 can be generally C-shaped portions having a defined opening 125, or side, for slidably or snappingly receiving and securing the tube or pipe 140 therein. Such a design allows for easy insertion, adjustment, and/or removal of the tube 140 relative to the portions 122, 124. One of ordinary skill in the art will recognize that other embodiments exist where grasping portions 122, 124 are generally U-shaped, elliptical-shaped, enclosed and cylindrical in shape, and the like. Generally, the grasping portions 122, 124 provide shroudable engagement and securement of at least a portion of the circumferential or outer surface of the tube 140 within the grasping portions 122, 124. In some embodiments, the C-shaped brackets 122, 124 can be juxtaposed and adjacently positioned such that the opening 125 of one bracket faces the opening 125 of the other bracket. The grasping portions 122, 124 can be sized to enclose or shroud about ½ of the circumference of the tube or pipe 140, while in other embodiments the grasping portions 122, 124 can be sized to shroud from about ¼ to nearly all of a portion of the circumference of the tube or pipe 140. Generally, the shroudable engagement of the grasping portions 122, 124 around the pipe or tube 140 can facilitate selective positioning and securement, which allows for increased precision in directing the blade portion 110 and edge 112 of the first cutting member 102 onto a desired target surface or cutting line of the tube 140.

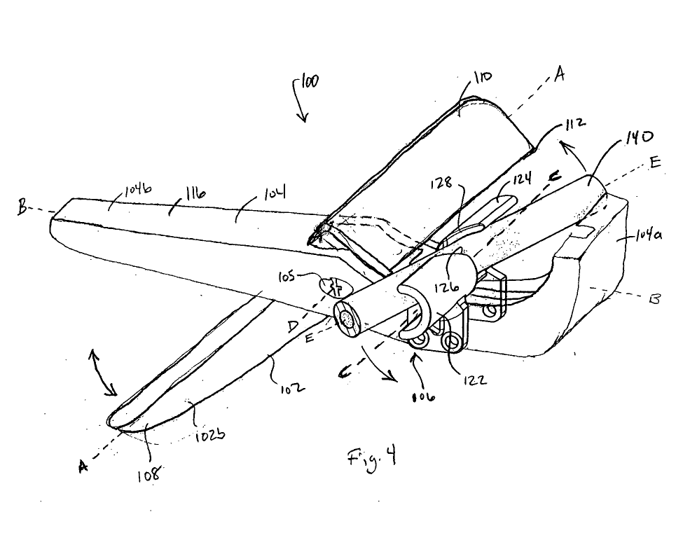

As shown in FIG. 3, in some embodiments, the grasping portions 122, 124 can be offset relative to each other, to increase ease of use and initial positioning of the tubing 140 and to reduce movement of the tubing 140 during cutting. Additionally, inner or interior edges 126, 128 of the grasping portions 122, 124, facing one another, can be tapered or otherwise angled to still further facilitate pivotably sliding of the tube or pipe 140 into and out of the grasping portions 122, 124, and to provide sufficient clearance for the blade portion 110 along the cutting path. The inclusion of these spaced apart and angled edges 126, 128 creates a gap and preferable positioning angle for initial insertion of the tubing 140 at a generally oblique angle. This angle is generally represented by axis E obliquely oriented with respect to axis C of the C-shaped grasping portions 122, 124, as best shown in FIG. 4. Various other positioning angles and insertion methods for the tubing within the portions 122, 124 are envisioned as well.

As shown in FIGS. 1 and 2, the grasping portions 122, 124 can comprise the mounting bracket or plate 130, which can facilitate coupling of the grasping portions 122, 124 to the second securing member 104. Furthermore, mounting brackets 130 enable selective connectivity of different grasping or holding portions to the second securing member 104. This allows a single cutting device 100 to be adaptable to receive and cut tubular objects 140 of varying sizes and cross-sectional shapes. As such, assemblies, mechanisms, and devices for providing such selective grasping portions 122, 124 connectivity known to those of ordinary skill in the art are envisioned for usage with the present invention. In addition to the connectivity options provided by the mounting brackets 130, such a configuration can further enable flexibility for the grasping portions 122, 124 by facilitating bending or flexing of the grasping portions 122, 124 with respect to the corresponding mounting brackets 130. One of ordinary skill in the art will recognize that various adjustable settings and structural configurations can be employed with the portions 122, 124 and bracket/plate 130 to enable such adjustment and flexibility options.

The component elements of cutting device 100 can be constructed of a myriad of materials suitable for cutting tool applications including metals, metal alloys, thermopolymers and combinations thereof. Further, this device 100 can be constructed to facilitate cutting of various thermopolymer pipes and tubular objects, such as those thermoplastic polymers commonly employed in the semiconductor processing and handling industry.

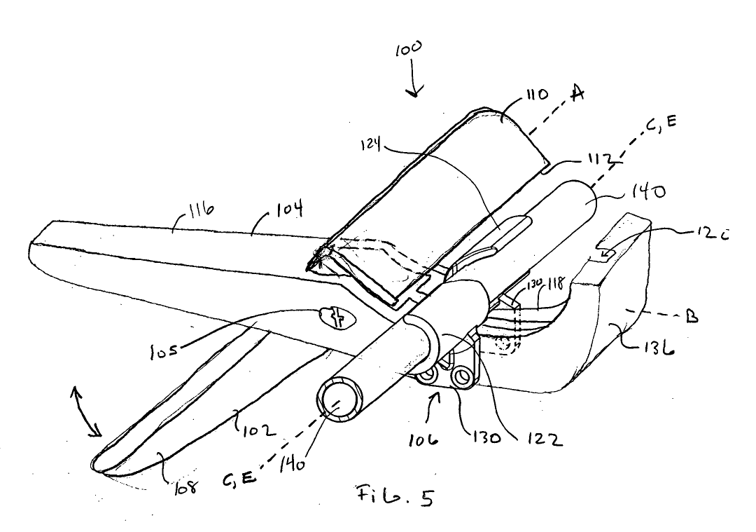

In using the cutting device 100, the tubular object (i.e., tubing) 140 can be slidably or snappingly inserted between the spaced apart C-shaped holding brackets 122, 124 along edges 126, 128 such that the tubing 140 is initially positioned along axis E, generally oblique with respect to axis C of the grasping portions 122, 124, as shown in FIG. 4. The tubing 140 is then pivoted or twisted to bring the tubing 140 into alignment with the openings 125 of the grasping portions 122, 124 along axis C, eventually aligning axes C and E (FIG. 5). This pivotal alignment of the tubing 140 in combination with the spaced apart and opposing openings 125, facilitates quick and easy shroudable engagement of the grasping portions 122, 124 around respective portions of the outer surface of the tubing 140. More particularly, a user can, using even a single hand, obliquely insert the tubing 140 between the portions 122, 124, twist or pivot the tubing 140 into the grasping portions 122, 124 in alignment with axis C transverse to the second securing member 116 and its axis B, and then actuate the first cutting member 110 down in a lever like action. To facilitate the described cutting, the blade edge 112 is moved down and through the tubing 140 as a result of this levering action, wherein the handle 108 of the first cutting member 102 and the handle 116 of the second securing member 104 are brought together about pivot 105. Squeezing the handle 108 of the first cutting member 102 and the handle 116 of the second securing member 104 together can pivot the first member 102 relative to the second member 104, which can thereby move the blade portion 110, and blade edge 112 specifically, into contact with a target cut line through the tubing 140 positioned within the positioning element 106. Again, the tubing 140 will extend out generally transverse from the second securing member 104 due to the placement and orientation of the positioning element 106. This pivotable cutting motion will ultimately sever the tubing 140 at a desired location along its length, with the tubing being substantially maintained and secured within the positioning element 106 during this cutting operation.

The embodiments above are intended to be illustrative and not limiting. Additional embodiments are within the claims. Although the present invention has been described with reference to particular embodiments, those skilled in the art will recognize that changes may be made in form and detail without departing from the spirit and scope of the invention.

1. A cutting device for cutting a tube comprising:
a first cutting member comprising a handle portion and a blade portion extending away from the handle portion, the blade portion having at least one blade edge for cutting a portion of the tube, the blade portion being pivotally movable along a cutting path;
a second securing member comprising a handle portion and a cradle portion, the second securing member being pivotally coupled to the first cutting member; and
a positioning element provided on the second securing member proximate the cradle portion and extending generally transverse from the second securing member, the positioning element being adapted to secure the tube such that the tube is securely held generally transverse to the blade edge and the second securing member when the blade edge is moving along the cutting path.

2. The device of claim 1, wherein the positioning element comprises at least one generally C-shaped grasping portion adapted to shroudably engage at least a portion of an outer surface of the tube.

3. The device of claim 2, wherein the at least one C-shaped grasping portion includes two adjacently aligned generally C-shaped grasping portions, each adapted to shroudably engage at least a portion of an outer surface of the tube.

4. The device of claim 2, wherein the at least one generally C-shaped grasping portion includes two adjacently offset generally C-shaped grasping portions adapted to shroudably engage at least a portion of an outer surface of the tube.

5. The device of claim 2, wherein the at least one generally C-shaped grasping portion includes an angled edge portion adapted to facilitate receipt of the tube therein.

6. The device of claim 2, wherein the at least one generally C-shaped grasping portion includes two aligned generally C-shaped grasping portions, each having an opening portion facing the opening portion of the other of the C-shaped grasping portions.

7. The device of claim 1, wherein the positioning element is adjustably coupleable to the second securing member.

8. The device of claim 1, wherein the second securing member includes a blade receiving channel to receive the blade portion during cutting.

9. The device of claim 1, wherein the positioning element is generally flexible to facilitate positioning and removal of the tube from the positioning element.

10. A cutting device for cutting a tubular object having a longitudinal axis defined therethrough, comprising:
a first cutting member having a cutting blade portion;
a second securing member pivotally coupled to the first cutting member to provide a pivotable cutting path for the cutting blade portion; and
a nesting portion provided on the second securing member, the nesting portion including at least one generally C-shaped grasping portion extending generally transverse from the second securing member, the at least one C-shaped grasping portion being adapted to securely position the tubular object in alignment such that the longitudinal axis of the tubular object is aligned generally transverse to the cutting path of the cutting blade portion.

11. The device of claim 10, wherein the at least one generally C-shaped grasping portion includes two adjacently aligned generally C-shaped grasping portions, each adapted to shroudably engage at least a portion of an outer surface of the tubular object.

12. The device of claim 10, wherein the at least one generally C-shaped grasping portion includes two adjacently offset generally C-shaped grasping portions adapted to shroudably engage at least a portion of an outer surface of the tubular object.

13. The device of claim 10, wherein the at least one generally C-shaped grasping portion includes an angled edge portion adapted to facilitate receipt of the tubular object therein.

14. The device of claim 10, wherein the at least one generally C-shaped grasping portion includes two aligned generally C-shaped grasping portions, each having an opening portion facing the opening portion of the other of the C-shaped grasping portions.

15. The device of claim 10, wherein the nesting portion is adjustably coupleable to the second securing member.

16. The device of claim 10, wherein the second securing member includes a blade receiving channel to receive the cutting blade portion during cutting.

17. The device of claim 10, wherein the nesting portion is generally flexible to facilitate positioning within and removal of the tubular object from the nesting portion.

18. A device for cutting a tubular object having a longitudinal axis defined therethrough, comprising:
a first cutting member having a cutting blade portion;
a second securing member pivotally coupled to the first cutting member to provide a pivotable cutting path for the cutting blade portion; and
a positioning element provided on the second securing member, the positioning element including a plurality of adjacently aligned generally C-shaped grasping portions extending generally transverse from the second securing member, the C-shaped grasping portions being adapted to securely position the tubular object in alignment such that the longitudinal axis of the tubular object is maintained generally transverse to the cutting path of the cutting blade portion during cutting.

19. The device of claim 18, wherein the plurality of generally C-shaped grasping portions includes two adjacently aligned generally C-shaped grasping portions, each adapted to shroudably engage at least a portion of an outer surface of the tubular object.

20. The device of claim 18, wherein the plurality of generally C-shaped grasping portions includes two adjacently offset generally C-shaped grasping portions adapted to shroudably engage at least a portion of an outer surface of the tubular object.

21. The device of claim 18, wherein each of the plurality of generally C-shaped grasping portions include an angled edge portion adapted to facilitate receipt of the tubular object therein.

22. The device of claim 21, wherein the angled edge portion facilitate the obliquely aligned insertion of the tubular object between the plurality of C-shaped grasping portions.

23. The device of claim 18, wherein the plurality of generally C-shaped grasping portions includes two aligned generally C-shaped grasping portions, each having an opening portion facing the opening portion of the other of the C-shaped grasping portions.

24. The device of claim 18, wherein the positioning element is generally flexible to facilitate positioning within and removal of the tubular object from the positioning element.

25. A method of cutting tubular objects having a longitudinal axis defined therethrough, comprising the steps of:
providing a cutting device including a first cutting member having a cutting blade portion, a second securing member pivotally coupled to the first cutting member to provide a pivotable cutting path for the cutting blade portion, and a positioning element provided on the second securing member, the positioning element including at least one generally C-shaped portion extending generally transverse from the second securing member;
positioning the tubular object within the at least one C-shaped portion of the positioning element such that the tubular object is securely aligned generally transverse from the second securing member and a desired target cutting line of the tubular object is positioned along the cutting path; and
pivotally actuating the cutting blade portion of the first cutting member toward the secured tubular object such that the cutting blade portion engages the target cutting line of the tubular object for cutting.

26. The method of claim 25, wherein the step of positioning the tubular object includes initially positioning the tubular object between two spaced generally C-shaped grasping portions at a generally oblique angle with respect to the C-shaped grasping portion.

27. The method of claim 26, further including the step of pivoting the obliquely positioned tubular object such that the tubular object is alignably engaged within the spaced generally C-shaped grasping portions generally transverse from the second securing member.

28. A cutting device for cutting a tube comprising:
first means for pivotable actuation having a blade portion, the blade portion having at least one blade edge for cutting a portion of the tube, the blade portion being pivotally movable along a cutting path;
second means for pivotable actuation being pivotally coupled to the first means for pivotable actuation; and
means for positioning the tube for cutting, provided on the second means for pivotable actuation and extending generally transverse therefrom, the means for positioning the tube for cutting being adapted to secure the tube such that the tube is securely held generally transverse to the blade edge when the blade edge is moving along the cutting path.

29. The device of claim 28, wherein the means for positioning the tube for cutting comprises at least one generally C-shaped grasping portion adapted to shroudably engage at least a portion of an outer surface of the tube.

30. The device of claim 28, wherein the means for positioning the tube for cutting comprises two adjacently aligned generally C-shaped grasping portions, each adapted to shroudably engage at least a portion of an outer surface of the tube.

31. The device of claim 28, wherein the means for positioning the tube for cutting comprises two adjacently offset generally C-shaped grasping portions adapted to shroudably engage at least a portion of an outer surface of the tube.

32. The device of claim 29, wherein the at least one generally C-shaped grasping portion includes an angled edge portion adapted to facilitate receipt of the tube therein.

33. The device of claim 29, wherein the at least one generally C-shaped grasping portion includes two proximate generally C-shaped grasping portions, each having an opening portion facing the opening portion of the other of the C-shaped grasping portions.

34. A method of cutting tubular objects having a longitudinal axis defined therethrough, comprising the steps of:
providing a cutting device including a first cutting member having a cutting blade portion, a second securing member pivotally coupled to the first cutting member to provide a corresponding lever action along a cutting path for the cutting blade portion, and a nesting element provided on the second securing member, the nesting element including two spaced apart and generally C-shaped portions extending generally transverse from the second securing member, each of the spaced C-shaped portions including an angled interior edge portion;
initially positioning the tubular object between the two spaced C-shaped portions at a generally oblique angle with respect to the axes of the C-shaped portions such that the tubular object is nestled down between the angled interior edge portions of the spaced apart generally C-shaped portions; and
pivoting the obliquely positioned tubular object such that the tubular object is alignably engaged within the spaced apart C-shaped portions generally transverse from the second securing member.

35. The method of claim 34, further including the step of actuating the cutting blade portion of the first cutting member in a lever action toward the secured tubular object such that the cutting blade portion engages a target cutting line of the tubular object for cutting.
